(19) United States
(12) Patent Application Publication
(10) Pub. No.: US 2002/0048494 A1
(43) Pub. Date: Apr. 25, 2002

(54) MACHINING METHOD FOR THREE-DIMENSIONAL CONNECTING SURFACES

(75) Inventor: ROLF HABERSTOCK, KUSSABERG (DE)

Correspondence Address: VENABLE BAETJER HOWARD & CIVILETTI, 1201 NEW YORK AVENUE NW, SUITE 1000, WASHINGTON, DC, 200053917

(73) Assignee: haberstock

(21) Appl. No.: 09/284,626

(22) PCT Filed: Oct. 14, 1997
(86) PCT No.: PCT/EP97/05648

(30) Foreign Application Priority Data
Oct. 16, 1996 (CH) 2532/96

(51) Int. Cl. B23C 1/00

(52) U.S. Cl. 409/132; 700/187

(57) ABSTRACT

In order in a method for a machine tool which has at least five axes and can be used to produce a joining face which is defined by fixed, geometrical variables and joins at least two main faces to one another and has at least two bends in different directions, to improve the quality of the surface and to shorten the traversing paths of the tool, it is proposed according to the invention to use a tool which has a lateral surface (12) which is provided with a rotationally symmetrical contour (13) on which at least one cutting edge is arranged, the contour (13) having with reference to a longitudinal section along the rotation axis (11) of the tool at least one section which is congruent with at least one section of one of the two bends (6) of the joining face (5), it being possible for the purpose of producing the joining face (5, 5′, 35) to guide the tool in the direction (19) of a longitudinal extent of the joining face (5, 5′, 35) so that the tool engages with the workpiece, and the alignment of the tool being performed with the aid of a geometrical variable dependent on the profile of the joining faces (5, 5′, 35) such that this variable can be set to be essentially constant and by virtue of this alignment a tangential face of the contour (13) of the tool is identical to a tangential face of one of the main faces (3, 4).

The invention relates to a method for a machine tool which has at least five axes and can be used to produce a joining face which is defined by fixed, geometrical variables and joins at least two main faces to one another and has at least two bends in different directions.

There is the basic problem in producing workpieces of imaging a face in accordance with its desired values, for example in a CAD system, and subsequently converting the geometrical data thus obtained into manufacturing data without losing information in the process. The loss of information means regular losses with regard to manufacturing accuracy. The production of surfaces of a workpiece in accordance with its desired values becomes more difficult the more complicated the mathematical description of the workpiece contour is. This applies, in particular, to arbitrarily shaped surfaces. Arbitrarily shaped surfaces can be described mathematically by families of curves in different spatial directions. It is possible, furthermore, for such faces arbitrarily shaped surfaces which cannot be divided up into basic geometrical surfaces such as, for example, spherical surfaces or paraboloid surfaces, to be described by interpolation between prescribed interpolation points or curves or by approximation by means of polygonal networks.

It is customary to use tools designed with end faces in the shape of spheres or hemispheres, such as ball-headed mills for example, to machine faces which are multiply curved. It is possible using such tools to produce at least approximately desired contours of even complicated surfaces such as arbitrarily shaped surfaces. If the radius of the calotte is smaller than the radius of the corresponding curvature of the face, the tool can follow the contour of the face without collision problems occurring, as can be the case, for example, with flat face mills owing to aftercutting by the tool. Nevertheless, this method remains unconvincing, since the quality thereby achievable for the faces produced is not satisfactory, on the one hand, and relatively many traversing paths are required, on the other hand.

These disadvantages come to bear to a particular extent when so-called “fillets”, in particular convexly curved fillets, are machined. Fillets are understood to be joining faces which are arranged respectively between at least two main faces of an arbitrarily shaped surface. Such joining faces can, for example, be convexly curved faces at edges at which two main faces abut one another. In order to machine convex fillets, it is customary to move a face mill whose end face is likewise convexly curved along the bend of the joining face. The individual machining tracks for the joining face can extend between a direction transverse to and a direction along the face curve. In order to machine the joining face along the entire extent of its length, so many cutting tracks are laid next to one another that the sum of the cutting widths of the individual tracks produces the joining face.

One disadvantage of this method is that the curved end face of the mill produces machining grooves which do not meet high demands placed on the surface quality. A further disadvantage is that it is difficult using this method to produce transitions of good quality between the joining face and the main faces bordering thereon. In order to be able to achieve a satisfactory surface quality, therefore, complicated and expensive re-machining is frequently necessary.

Owing to the alignment of the individual cutting tracks transverse to or also obliquely relative to the longitudinal extent of the joining face, there is a need for a relatively high number of individual cutting tracks for machining the joining face. In addition, the sum of these cutting tracks and of the number of the idle traversing paths caused by them produces a total traversing path of the tool which is very long in relation to the size of the face to be machined. However, long total traversing paths produce long machining times which, in turn, lead to high costs for the production of such parts.

With regard to previously known methods, the object of the present invention is therefore to provide a method by means of which it is possible in the case of abrading machining of convexly curved joining faces to achieve a good manufacturing quality in conjunction with short production times.

The object is achieved in accordance with the invention in the case of a method mentioned at the beginning by using a tool which has a lateral surface which is provided with a mainly concave and rotationally symmetrical contour on which at least one cutting edge is arranged. With reference to a longitudinal section along the rotation axis of the tool, the contour has at least one section which is congruent with at least one section of one of the two bends of the joining faces. Furthermore, for the purpose of producing the joining face, the tool can be guided in the direction of a longitudinal extent of the joining face such that the tool engages with the workpiece and the alignment of the tool is performed with the aid of a geometrical variable dependent on the profile of the joining face, it being possible to set this variable to be essentially constant. Finally, during this traversing movement of the tool, a tangential face respectively tangential plane of the contour of the tool is identical to a tangential face respectively tangential plane of one of the main faces. Preferred embodiments of the invention follow from the dependent claims.

In this case, a tangential face respectively tangential plane is understood to be the face which is formed by all the tangents to the joining or guiding surface at a specific point.

This method already differs from conventional methods simply on the basis of the profile of the cutting track with reference to the longitudinal extent of the joining face (fillet) The number of individual tracks of the tool, and thus also the number of time-consuming changes in direction of the tool can be substantially reduced by the method according to the invention. Since it is provided in the method according to the invention to machine the workpiece on each cutting track by means of the lateral surface of the tool in a planar fashion, it is possible to avoid disadvantageous cutting conditions such as occur when using the end face of a milling tool. Specifically, the unfavourable cutting rate of v=0 prevails at the point of intersection of the tool axis and the end face of the tool. There is thus no cutting of the material at this point, but rather a displacement of it. This also can contribute to unsatisfactory surface qualities. In accordance with the present invention; however, the lateral surface of a tool, in particular a form mill, is used as cutting surface, it being possible to ensure thereby that every point of the cutting surface is at a distance from the tool axis which differs from zero. The previously described unfavourable cutting conditions can thereby be avoided.

However, it is not only possible by means of the method according to the invention to shorten the total traversing paths and improve the surface quality. Since formed tools can be used in the method, it is also possible to produce surfaces having very low tolerances.

It is true that it has also long been known from the prior art to machine edges of a workpiece with the aid of form mills. However, this previously known method is used exclusively in the case of joining faces for which the milling track extends only in a plane which is at right angles to the tool axis.

In a preferred refinement of the method according to the invention, it is provided that the geometrical variable is a spatial angle enclosed by the rotation axis of the tool with a normal vector of the joining surface. Since the aim using this method is to provide continuous transitions between the joining face and a main face, normal vectors and the tangential surfaces defined thereby are particularly suitable as the geometrical variable by means of which the alignment of the rotation axis of the tool is performed.

“Continuous” is to be understood in connection with the present context in accordance with the mathematical definition of “continuity” In simple terms, “continuous” thus signifies that the gradient at the point considered is always identical no matter from which side this point on the joining face is approached.

The invention is explained in more detail below with the aid of exemplary embodiments represented diagrammatically in the figures, in which:

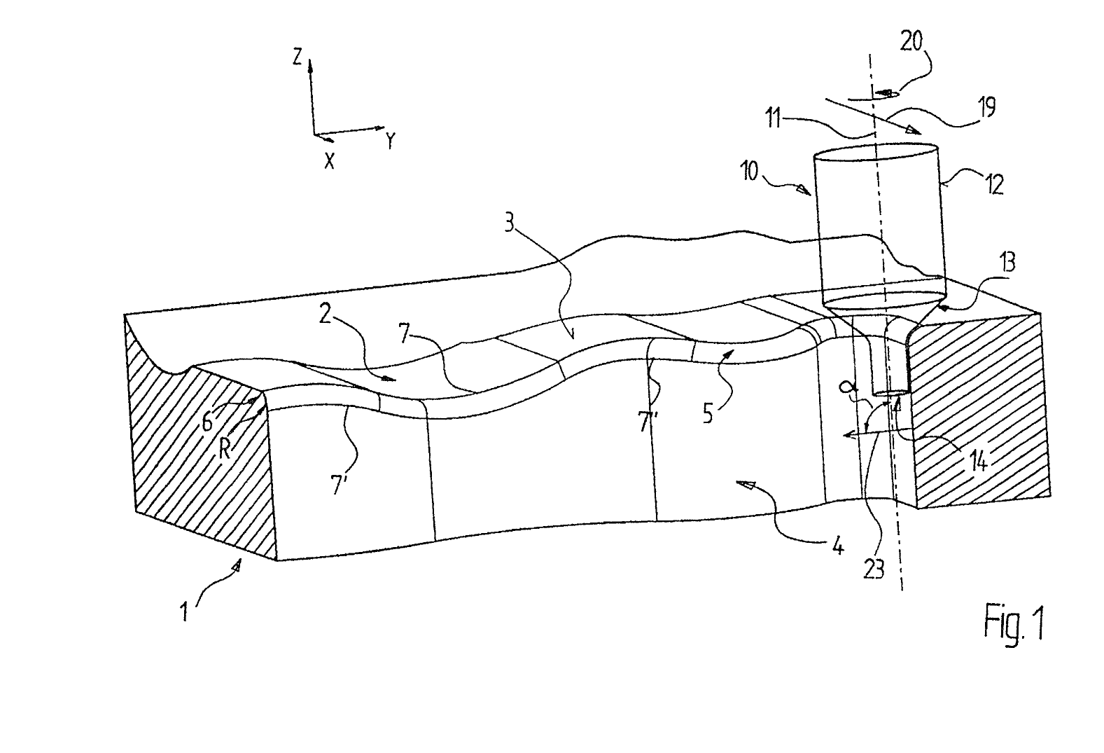

FIG. 1 shows a perspective sectional representation of a part of a workpiece already produced by a tool using the method according to the invention,

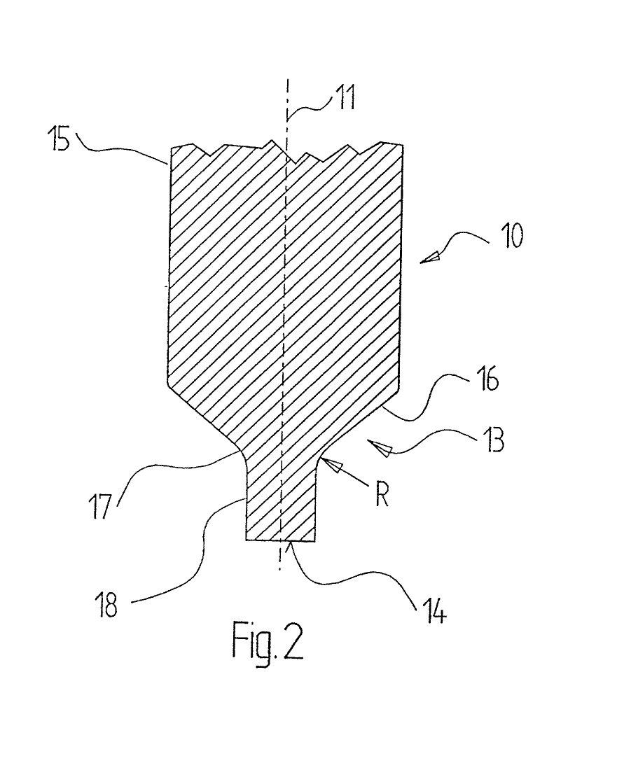

FIG. 2 shows a longitudinal section along the axis of a partially represented tool in accordance with FIG. 1,

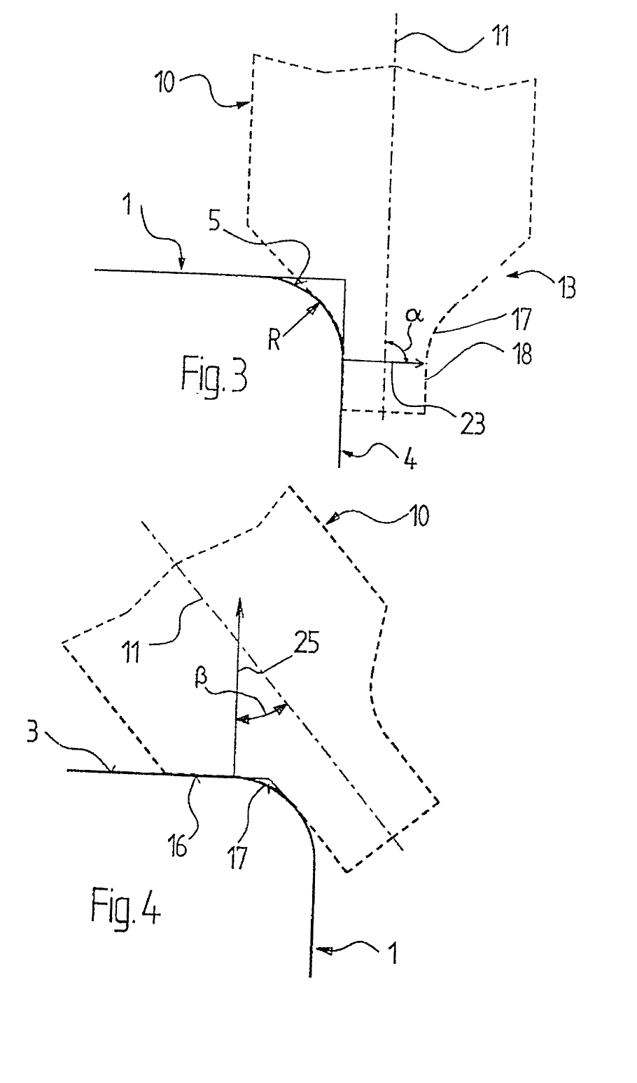

FIG. 3 shows a detail of a front view of the workpiece shown in FIG. 1 and of the tool,

FIG. 4 shows a representation in accordance with FIG. 3, in which the tool is located on another cutting track,

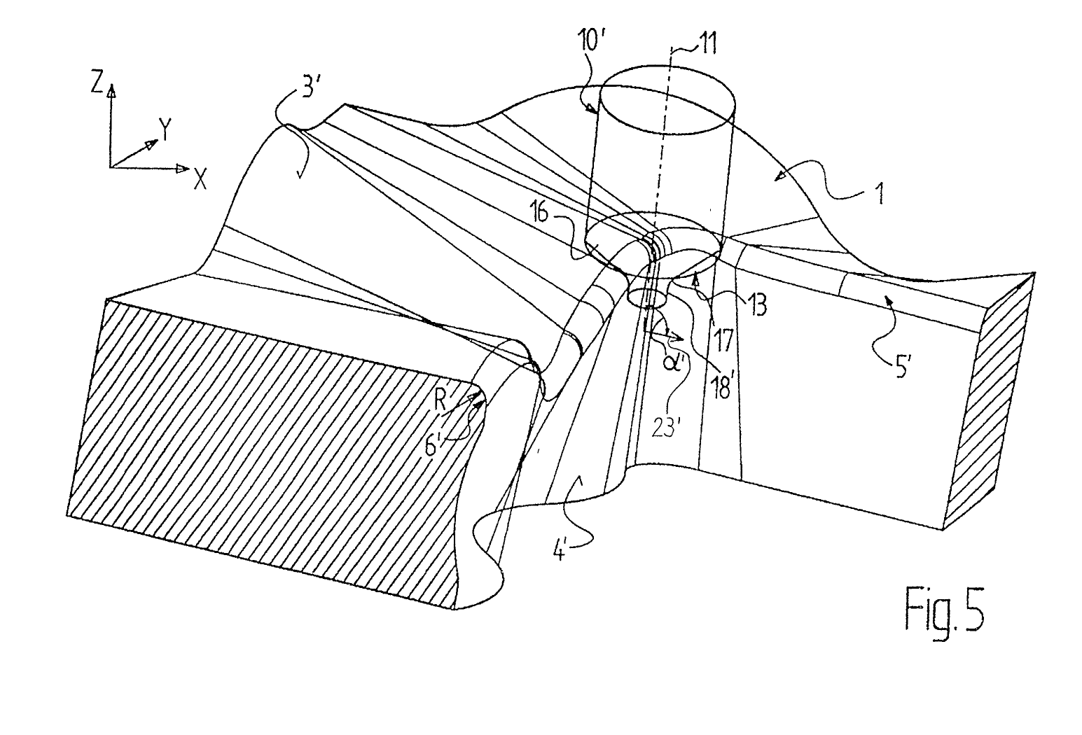

FIG. 5 shows a representation in accordance with FIG. 1, in which the machining according to the invention of a further workpiece is represented,

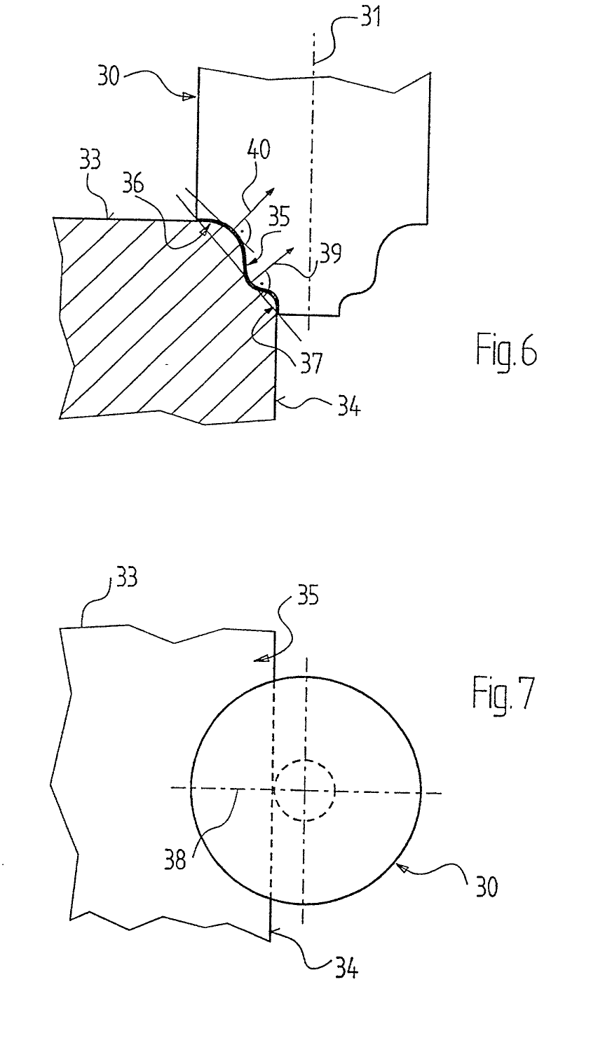

FIG. 6 shows a partially represented sectional view of the machining according to the invention of a further joining face, and

FIG. 7 shows a top view of the workpiece and tool from FIG. 6.

FIG. 1 shows a workpiece 1 with a relatively simple arbitrarily shaped surface 2. Because of its geometric configuration, the arbitrarily shaped surface 2 can be subdivided into various subfaces. This subdivision is performed in the present case on the basis of relatively simple mathematical functions by means of which individual subfaces can be described. Thus, the main faces denoted by 3 and 4 are essentially two-dimensional planes. The main face 3 has depressions at several points, for which reason it has an extension into a third spatial dimension. A joining face 5 which joins the two main faces 3, 4 to one another is provided with a first bend 6 which corresponds to a circular segment of radius R and has a first aperture angle. The joining face 5 is provided with this bend 6 along its entire longitudinal extent and merges tangentially respectively continuously into the respectively bordering main face 3, 4. The joining face 5 is provided, furthermore, with a second bend 7 which is located in the region of one of the depressions in the main face 3.

Also represented in FIG. 1 is a tool, designed as a form mill 10, which is located on a machine tool (not shown in more detail) having five axes. The mill 10 is symmetrical with reference to its rotation axis 11. A lateral surface 12 of the mill 10 has a section which is provided with a specific contour 13 and on which cutting edges (not represented in more detail) are located. The end face 14 of the tool is, by contrast, not provided with cutting edges

The contour 13 of the mill 10 is at a smaller distance from the axis 11 than a shaft 15 of the mill, as is to be seen in the representation of FIG. 2. Furthermore, viewed in a longitudinal section along the tool axis, the contour 13 can be described by a plurality of basic geometrical shapes (FIG. 2). A first section of the contour 13 comprises a straight line 16 through which the mill 10 tapers in the direction of its end face 14. Adjoining the straight line 16 is an arc 17 of radius R, which merges, in turn, into a second straight line 18 aligned parallel with the axis 11. The circular arc 17 lends the contour 13 of the mill a concave section.

The mill 10 is guided along the main face 4 in the direction of the arrow 19 in order to produce the desired contour of the joining face 5. It can be seen from the direction of rotation of the mill as indicated by the arrow 20 that a climb-cut milling method is used for the purpose. However, it would be equally possible to produce the cutting track by means of an up-feed milling method.

A detail of the workpiece 1 shown in FIG. 1 is represented in FIG. 3 and in FIG. 4, in a front view in each case. In addition, the two figures respectively show an instantaneous alignment of the mill in the course of the first cutting track (FIG. 3) and of the second cutting track (FIG. 4). Furthermore, it is shown in each case with which alignment the mill 10 is guided in order to produce the respective cutting track on the workpiece.

It is to be seen in FIG. 3 that on the first cutting track the mill 10 cuts with a first section of its contour 13. This contour section is composed of the straight line 18 and the arc 17. The straight line 18 machines a part of the main face 4 which borders on the joining face 5. Since the arc 17 of the tool has a smaller aperture angle than the arc (bend 6) of the joining face 5, the first cutting track can only produce a part of the desired contour of the joining face 5. In other embodiments of the method according to the invention, however, it would also be possible in the case of workpieces suitable therefor completely to manufacture a joining face with only one cutting track.

In order to produce the predetermined desired contour of the joining face 5, the mill 10 traces a predetermined traversing path on its first cutting track. The traversing path is determined, on the one hand, from the fact that a spatial angle α between an instantaneous normal vector 23 to the (desired contour of the) joining face 5 and the rotation axis 11 of the mill 10 is constant over the entire traversing path of the first cutting track. This normal 23 is uniquely defined, for which reason the cutting track of the mill 10 can be described exactly. Since the joining face 5 is intended to transit continuously into the main face 4, an (imaginary) plane has to be formed at right angles to the instantaneous traversing direction of the mill 10 in order to determine the base point of the normal vector 23. Together with the joining face 5, this plane forms a contact or cutting curve extending in a curved fashion. The base point of the normal vector 23 is the end point, bordering on the main face 4, of the cutting or contact curve. The previously mentioned (imaginary) plane also corresponds to the (imaginary) plane in which the normal vectors at each point of the contact or cutting curve lie. In this case, a cutting curve can also be understood as that contact curve which is produced by the tool which bears—at least partially—congruently with its curvature against the curvature of the workpiece. The cutting curve defined in this way is also identical to the previously described contact or cutting curve.

On the other hand, the alignment of the mill on its traversing path is also determined by the fact that on the traversing path along the first cutting track the rotation axis 11 of said mill fulfils the condition in accordance with which the rotation axis 11 is always located in the abovedescribed (imaginary) plane. This plane corresponds to the plane of the drawing in the exemplary embodiment shown in FIG. 3.

In this case, the spatial angle a is to be selected such that the straight line 18 is aligned parallel respectively tangential to the main face 4. So that this can be fulfilled, a geometrical shape which corresponds to the corresponding section of the main face 4 is selected for the section, engaging with the main face 4, of the contour 13 of the mill 10 with the straight line 18. Since, because of the geometrical configuration and the alignment of the mill 10, it is ensured that the straight line extends parallel to the main face 4 over the entire traversing path of the first cutting track, the result is a continuous transition of the main face 4 to the joining face 5. It follows from this that at each point of the transition from the joining face 5 to the main face 4 the tangential surface of the last named corresponds to the respective tangential surface of the joining face 5. Of course, it holds inversely that at each point of the transition the respective tangential surface of the joining face is equal to the main face 4 or the tangential surface of the main face 4. These tangential surfaces can be uniquely described by the normal vector 23 already mentioned previously.

Contrary to FIG. 3 the normal vector in the representation of FIG. 1 is not arranged on a line of transition, at which the main face 4 changes over into the joining face 5. In order to ensure clarity of FIG. 1, the representation is such that a parallel translation of normal vector 23 has been made with respect to its true orientation.

Finally, to orientate the mill, it would be possible to use other normal vectors than the ones, which are arranged on the curve between the joining face 5 and the main face 4.

The second cutting track of the mill 10 is represented in FIG. 4. As is to be seen, for this purpose the mill 10 bears with its straight line 16 against the main face 3 of the desired contour of the arbitrarily shaped surface 2. Here, as well, the circular arc 17 of the contour 13 bears with its complete length against the desired contour of the joining face 5. The aperture angle of the circular arc 17 is selected such that there is a slight overlap between the first and the second cutting track. A burr can thereby be prevented from remaining between the two cutting tracks. Of course, this could also be achieved by having the two cutting tracks abut one another exactly.

The alignment of the mill 10 in the course of its traversing path along the second cutting track is likewise uniquely predetermined by surface normals to the joining face. In this case, as well, the mill is to be guided such that a tangential surface at the circular arc 17 corresponds to a tangential surface of the main face 3. For this purpose, the two tangential surfaces are respectively to be applied at the point along the line at which the main face 3 and the joining face 5 abut one another and which the mill 10 instantaneously touches on its traversing path along the second cutting track at the instant considered. Here, as well, a normal vector 25 is thus uniquely determined, a constant spatial angle β being maintained between the respective normal vector 25 and the axis 11 over the entire traversing path of the second cutting track.

FIG. 5 shows a further exemplary embodiment of the method according to the invention, which is essentially identical to that in FIG. 1. For this reason, the same elements are provided with the same reference symbols. The workpiece 1 represented in FIG. 5 has main faces 3′ and 4′ which are provided with a concave or convex curvature, in a direction parallel to the plane of the drawing in each case. Since here, as well, the joining face 5′ provided with a circular curvature 6′ merges continuously and thus tangentially into the respective main face 3′, 4′ in the case of this workpiece the bend 6 is provided with an aperture angle which is somewhat larger than by comparison with the exemplary embodiment previously described.

On its cutting surface, the mill 10′ has essentially the same contour 13, and thus also the same radius 17, as the mill 10. Only the straight line 18′ is somewhat shorter by comparison with the straight line 18. The traversing path and the alignment of the mill 10′ is determined in accordance with the conditions described in connection with the mill 10. In order that here, as well, continuous, and thus non-kinked transitions can be produced between the joining face 5′ and the two main faces 3′, 4′, there is a need to orientate the rotation axis 11 differently. In the machining of the first cutting track which is shown in FIG. 5, the rotation axis 11′ is therefore tipped clockwise in the plane of the drawing so that a constant spatial angle a is produced with the rotation axis 11. Here, as well, the contour of the mill 10′ bears with the circular arc 17 congruently against the bend 6 of the joining face such that the straight line 18′ thereby extends tangentially relative to the joining face 5′ and the main face 4′. In correspondence to the representation of FIG. 1 and in order to ensure clarity of the representation, the normal vector 23′ in FIG. 5 is displaced in parallel with respect to its true orientation.

By contrast, because of the profile of the main face 3′, on the second cutting track (not represented), the mill is inclined less steeply in the anticlockwise direction—by comparison with the cutting track shown in FIG. 4. As a result, the straight line 16 is aligned tangentially relative to the main face 3′ at every point on the traversing path of the mill 10′.

Yet a further exemplary embodiment is shown in FIG. 6, in which the joining face 35 of a workpiece can be manufactured using only one cutting track. In order to produce the joining face 35, the workpiece is machined along the edges of two main faces 33 or 34 using a rotationally symmetrical form mill 30. The instantaneous traversing direction of the mill 30 shown in FIG. 6 extends orthogonally relative to the plane of the drawing. As is to be seen, in the cross-sectional view which is shown the joining face 35 is a face which is curved multiply and in different directions. Overall, the joining face 35 extends in a mainly convex fashion between the two main faces 33, 34.

It follows from this that the contour of the form mill is likewise designed in a mainly convex fashion and completely congruent with the joining face 35. The lateral surface of the mill 30, which is fitted with cutting edges in the region of the contour in a planar fashion, bears with its end pieces 36, 37 against the workpiece in such a way in each case that the end pieces 36, 37 extend tangentially relative to the main faces 33, 34 Since the cutting plane of the representation of FIG. 6 extends both through the rotation axis 31 and through the contact curve 38 (FIG. 7) of the mill 30 with the desired contour of the workpiece, it is also possible, by way of example, to show two vectors 39, 40 of the normal vector family of the contact curve 38 The normal vectors to the respective contact curve all lie in a common plane, specifically the respective (imaginary) plane already mentioned above. The rotation axis 31 of the mill 30 is located at each point of the traversing path in the respective instantaneous (imaginary) plane.

It is not only predefined continuous transitions from the joining faces to main faces of an arbitrarily shaped surface which can be produced by the previously described alignment of the mill with the aid of surface normals. With the aid of a specific normal vector in each case, this alignment can also substantially ease the development of NC programs which are drawn up with the aid of an NC programming system.

The geometrical shape of an arbitrarily shaped surface is generally uniquely described by a CAD system, for example with the aid of Bezier curves or by NURBS (Non Uniform Rational B Splines). It is thereby also possible to form the tangential surface at every point on the desired contour of the arbitrarily shaped surface, which tangential surface can, in turn, be defined in the CAD system by its normal vector. It is therefore possible with the aid of a NC programming system, which can take over the geometrical data of the arbitrarily shaped surface, to determine the base points of the normal vectors which are used to align the tool. The aggregate of these base points forms a line along which the mill is to be moved with a specific point on its contour. This point is to be selected such that together with the line of the base points the desired orientation of the mill is produced. The traversing path of the mill is thereby uniquely determined, and can be generated exactly by the NC programming system.

Although the method according to the invention is preferably used as a milling method, it can, of course, also be used in conjunction with any other abrading machining method such as, for example, grinding or eroding.

1. Method for producing a joining face (5) by using a machine tool which has at least five axes, the joining face (5, 5′, 35) of a workpiece joining at least two main faces (3, 4; 3′, 4′; 33, 34) to one another and having at least two bends (6; 7, 7′, 7″) in different directions, in which method
it is possible to use a tool which has a lateral surface (12) which is provided with a rotationally symmetrical contour (13) on which at least one cutting edge is arranged,
with reference to a longitudinal section along the rotation axis (11) of the tool, the contour (13) has at least one section which is congruent with at least one section of one of the two bends (6) of the joining face (5)
for the purpose of producing the joining face (5, 5′, 35), the tool can be guided in the direction (19) of a longitudinal extent of the joining face (5, 5′, 35), such that the tool engages with the workpiece, and
the alignment of the tool is performed with the aid of a geometrical variable dependent on the profile of the joining faces (5, 5′, 35) such that this variable can be set to be essentially constant and by virtue of this alignment a tangential face at the contour (13) of the tool is identical to a tangential face at one of the main faces (3, 4).

2. Method according to claim 1, in which the geometrical variable can be set to be essentially constant over the entire traversing path of the tool on a cutting track along the joining face (5).

3. Method according to one or both of the preceding claims, in which the geometrical variable is a solid angle (α, β, α′) enclosed by the rotation axis (11) of the tool with a normal vector (23, 25, 23′) of the joining face (5, 5′).

4. Method according to claim 3, in which the normal vector (23, 25, 23′) is located on a contact or cutting curve between the joining face (5, 5′) and the contour (13) of the tool.

5. Method according to one of more of the preceding claims, in which the rotation axis (11) can be aligned such that it lies in a plane in which normal vectors (39, 40) are also situated on a contact curve (38) between the tool and the desired contour of the joining face (5, 5′, 35).

6. Method according to one of the preceding claims, in which the engaged tool is guided in a longitudinal direction of the joining face (5, 5′, 35) along the latter such that the tool also engages with at least one section of one of the main faces (3, 4, 3′, 4′; 33, 34).

7. Method according to one or more of the preceding claims, in which the contour (13) of the tool is configured such that it is possible to produce a joining face (5, 5′, 35) which is convexly curved in a longitudinal direction.

8. Method according to one or more of the preceding claims, in which the contour (13) has a mainly concavely curved section.

9. The use of the method according to one or more of the preceding claims for the purpose of producing machine-readable data, the data corresponding to a traversing path of the tool on the joining face (5).

10. Tool for performing the method according to one or more of the preceding claims 1 to 8, with which a joining face of at least two main faces can be machined characterized by means of a lateral surface (12), which has a rotationally symmetrical contour, on said surface at least one cutting edge is arranged, whereby—with respect to a longitudinal cross section along the rotational axis (11) said contour (13) is provided with at least one segment, which is congruent with at least one segment of one of the two bends (6) of the joining face (5).
